(19) United States
(12) Patent Application Publication
(10) Pub. No.: US 2023/0076413 A1
(43) Pub. Date: Mar. 9, 2023

(54) METHOD AND DEVICE FOR OPERATING A TRACTOR INCLUDING A TRAILER

(71) Applicant: Robert Bosch GmbH, Stuttgart (DE)

(72) Inventors: Jerg Pfeil, Cleebronn (DE); Simon Hackenbroich, Ostfildern (DE)

(21) Appl. No.: 17/898,086

(22) Filed: Aug. 29, 2022

(30) Foreign Application Priority Data
Sep. 7, 2021 (DE) 10 2021 209 840.1

(51) Int. Cl. B60T 8/17; G08G 1/16

(52) U.S. Cl. CPC B60T 8/1708; G08G 1/167; B60T 2230/06; B60T 2210/32

(57) ABSTRACT

A method and a device for operating a tractor including a trailer. The method includes detecting the surroundings behind the tractor through the clearance underneath the trailer using a surroundings sensor system, which, for this purpose, is mounted close to the roadway surface from the tractor, in particular underneath a connection between the tractor and the trailer, the surroundings sensor system including at least one video sensor. The method further includes determining objects in these surroundings, which are not encompassed by the trailer, by recognizing individual, in particular moving, integral parts of the trailer as such and excluding these in a targeted manner, determining a driving strategy for the tractor depending on the objects in the surroundings, and operating the tractor depending on the driving strategy.

### CROSS REFERENCE

The present application claims the benefit under 35 U.S.C. § 119 of German Patent Application No. DE 10 2021 209 840.1 filed on Sep. 7, 2021, which is expressly incorporated herein by reference in its entirety.

### FIELD

The present invention relates, among other things, to a method for operating a tractor including a trailer, including a step of detecting the surroundings behind the tractor through the clearance underneath the trailer, a step of determining objects in these surroundings, a step of determining a driving strategy for the tractor depending on the objects in the surroundings, and a step of operating the tractor depending on the driving strategy.

### SUMMARY

A method according to an example embodiment of the present invention for operating a tractor including a trailer includes a step of detecting the surroundings behind the tractor through the clearance underneath the trailer with the aid of a surroundings sensor system, which, for this purpose, is mounted close to the roadway surface from the tractor, in particular underneath the connection between the tractor and the trailer, the surroundings sensor system including at least one video sensor. The method also includes a step of determining objects in these surroundings, which are not encompassed by the trailer, by recognizing individual, in particular moving, integral parts of the trailer as such and excluding these in a targeted manner, a step of determining a driving strategy for the tractor depending on the objects in the surroundings, and a step of operating the tractor depending on the driving strategy.

A driving strategy is to be understood to mean, for example, instructions in the form of data values, which may be transmitted to further units of the vehicle with the aid of a data interface. These may be output to a driver of the tractor with the aid of an output unit and/or utilized for carrying out a driver assistance function, etc. Operating the tractor is to be understood here to mean implementing the driving strategy, i.e., for example, outputting the information and/or intervening in a lateral and/or longitudinal control of the tractor, etc. In one possible specific embodiment, the operation also includes, for example, carrying out safety-relevant functions (“focusing” an airbag, fastening the safety belts, etc.) and/or further (driver assistance) functions.

A surroundings sensor system is understood to mean, for example, at least one video sensor and/or at least one radar sensor and/or at least one LIDAR sensor and/or at least one ultrasonic sensor and/or at least one further sensor, which is designed for detecting the surroundings in the form of (surroundings) data values. The surroundings sensor system includes, for example, a processing unit (processor, working memory, memory unit) having a suitable software for evaluating these data values and determining specific objects (in this case, for example, other vehicles, etc.). In one further specific embodiment, the surroundings sensor system does not include this processing unit itself, but rather is connected to this processing unit, which is also encompassed by the tractor, with the aid of a suitable data interface.

Mounting the surroundings sensor system close to the roadway surface is to be understood to mean that the surroundings sensor system is mounted, for example, at a height between approximately 10 cm and 60 cm in such a way that the surroundings may be detected despite the trailer by way of the recording taking place underneath the trailer, for example, in the case of a video sensor. The actual height may depend on the configuration of the trailer and the configuration of the connection between the tractor and the trailer, since the appropriate surroundings sensor system generally must be mounted underneath this connection.

Objects in the surroundings are to be understood to mean, for example, further vehicles, pedestrians, obstacles, etc.

Moving integral parts of the trailer are to be understood to mean that individual integral parts move, for example, only temporarily in relation to the surroundings (i.e., not necessarily permanently). In this way, identically moving integral parts may be combined and determined as the trailer (or portions of the trailer).

The method according to an example embodiment of the present invention may advantageously achieves an object of enabling a reliable operation of a tractor and increasing the safety in traffic overall. Specifically, for a tractor including a trailer, it may be difficult, depending on the surroundings and, for example, traffic, etc., for a driver of the tractor or also in the case of actions of the tractor taking place in an automated manner, to oversee or detect the surroundings and, thereby, determine possible risks (for example, to pedestrians, etc.) and appropriately handle these.

The method according to the present invention applies here for the tractor including a trailer by the surroundings behind the tractor being detected underneath the trailer and objects in these surroundings being determined, with individual, in particular moving, integral parts of the trailer being recognized as such and excluded in a targeted manner.

Preferably, the individual integral parts of the trailer are excluded by distinguishing these individual integral parts from the objects in the surroundings by utilizing an optical flow.

Due to the utilization of an optical flow, it is possible to recognize the integral parts of the trailer moving with the tractor as such and to distinguish these from the objects in the surroundings, since these move differently. In addition, changes in the surroundings, such as, for example, an approaching vehicle, may also be perceived in this way. Moreover, due to the recognition of the movement and of the movement direction, the criticality for a subsequent driving scenario may be established, such as, for example, an approaching pedestrian during a backup maneuver. Due to the uniform movement of an object, the object may be demarcated from the surroundings.

According to an example embodiment of the present invention, preferably, a neural network is utilized for determining the objects and/or for excluding the individual integral parts of the trailer.

As a result, it is possible to detect and to classify objects in the detection range of the surroundings sensor system. Due to the trained features, other vehicles or obstacles may be detected and utilized for determining the driving strategy. Due to a training carried out specifically for the position of the surroundings sensor system (in relation to the tractor), the trailer may be perceived as an object which belongs to the tractor, and, thereby, incorporated as additional information into a surroundings model or excluded during a determination of objects in these surroundings. A neural network may also be utilized for detecting movement directions and gestures of the detected objects, in order, for example, to determine the intention of the movement and, thereby, to determine the driving strategy according to demand.

In one possible specific embodiment of the present invention, the optical flow and the neural network may also be combined with each other, in order to improve the method overall.

Preferably, the determination of the objects includes determining a radiation characteristic of at least one further vehicle in the surroundings. The determination of the vehicle strategy takes place depending on the radiation characteristic.

A radiation characteristic is to be understood to mean, for example, color and/or an interval of the radiation of one or multiple headlight(s) of the at least one further vehicle. Since, for example, the video sensor directed rearward as viewed from the tractor detects a front and/or side of the at least one further vehicle, a likely action of the at least one further vehicle may be determined as a result by detecting headlights, daytime running lights, flashing lights, etc., and incorporated in the determination of the driving strategy. Due to a flashing of the rear traffic, therefore, for example, a passing may be determined early and/or, for example, the lane in which the at least one further vehicle is located may be detected due to the position of the headlights and/or the distance and movement direction may be determined from the rate of change of the headlight intensity. Here, it is advantageous, for example, that the relevant object does not necessarily need to be completely detected.

According to an example embodiment of the present invention, preferably, the surroundings are detected by way of the surroundings sensor system additionally including at least one further sensor, which is not identical in relation to the video sensor, in particular a radar sensor. The objects are determined by way of the surroundings detected with the aid of the video sensor being fused with the surroundings detected with the aid of the at least one further, non-identical sensor.

A sensor, which is non-identical in relation to the video sensor, is to be understood here, for example, to be a radar sensor and/or a LIDAR sensor, and/or an ultrasonic sensor, and/or one further sensor, which is designed for detecting the surroundings.

Therefore, for example, the (first) surroundings data values, which are gathered with the aid of the video sensor, are fused with the (second) surroundings data values, which are gathered with the aid of a radar sensor. This represents a redundant approach for detecting the surroundings behind the tractor. The fusion may be carried out in this case, for example, with the aid of individual features of the detected and determined objects by way of the reflections of the radar being transmitted with the individual pixel regions of the captured images (of the video sensor), situated on top of one another in a shared coordinate system, and appropriately superimposed. On this basis, the objects may be created and, thereby, determined and classified. This also advantageously increases the recognition rate and reduces misdetections.

A device according to an example embodiment of the present invention, in particular a control unit, is configured for carrying out all steps of the method(s) according to the present invention for operating a tractor including a trailer.

According to an example embodiment of the present invention, for this purpose, the device includes, in particular, a processing unit (processor, working memory, memory medium) and a suitable software, in order to carry out the method(s) according to the present invention. Moreover, the device includes an interface, in order to send and receive data values with the aid of a wired and/or wireless link, for example, to further units of the automated vehicle (control units, communication units, surroundings sensor systems, etc.).

Moreover, a computer program is provided, including commands which prompt a computer to carry out a method as recited in one of the method(s) according to the present invention for operating a tractor including a trailer when the computer program is run by a computer. In one specific example embodiment of the present invention, the computer program corresponds to the software encompassed by the device.

In addition, a machine-readable memory medium is provided, on which the computer program is stored.

Advantageous refinements of the present invention are disclosed herein.

### BRIEF DESCRIPTION OF THE DRAWINGS

Exemplary embodiments of the present invention are represented in the figures and are described in greater detail below.

FIG. 1 shows a first exemplary embodiment of the method according to the present invention for operating a tractor including a trailer.

FIG. 2 shows a second exemplary embodiment of the method according to the present invention for operating a tractor including a trailer.

FIG. 3 shows an exemplary embodiment of the method according to the present invention for operating a tractor including a trailer in the form of a flowchart.

### DETAILED DESCRIPTION OF EXAMPLE EMBODIMENTS

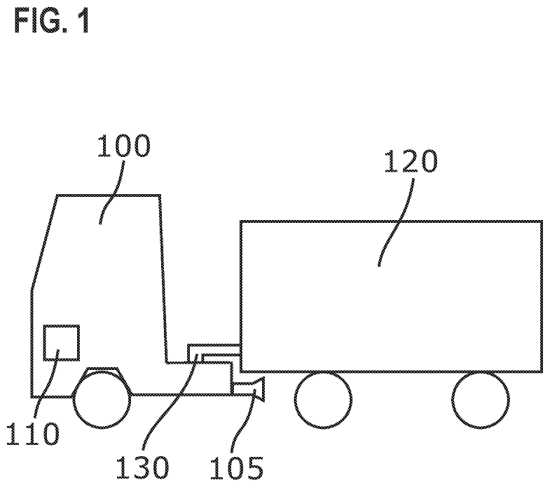

FIG. 1 shows an exemplary embodiment of method 300 according to the present invention, a tractor 100 including a trailer 120 being shown here in a simplified manner and in a side view, which are coupled to each other with the aid of a connection 130. Tractor 100 includes device 110 according to the present invention. Moreover, tractor 100—shown here merely by way of example—includes a surroundings sensor system 105, which, in order to carry out method 300, is mounted for this purpose close to the roadway surface from tractor 100, in particular underneath connection 130. This enables a detection 310 of the surroundings behind tractor 100 through the clearance underneath trailer 120 due to the fact that, due to the distance between an underbody of trailer 120 and the roadway, recordings may be recorded behind trailer 120, for example, with the aid of a video sensor.

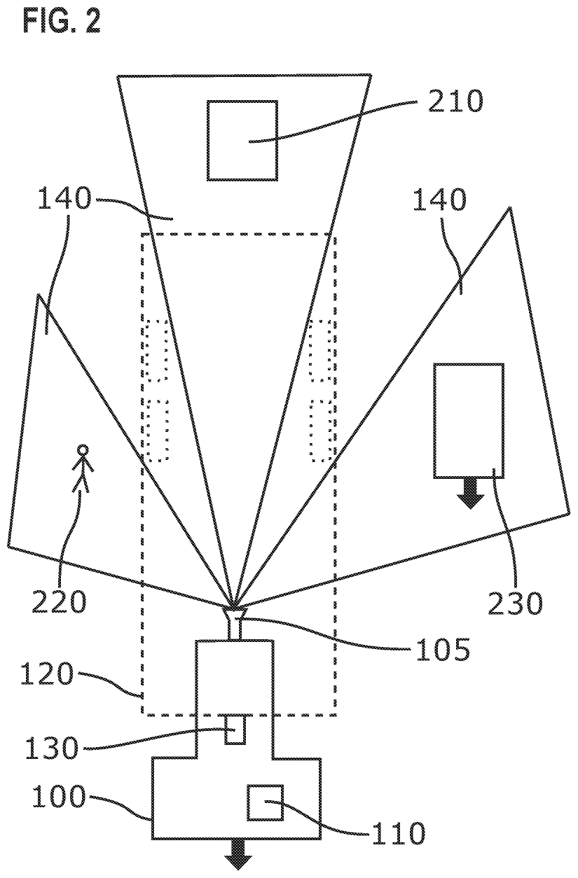

FIG. 2 shows an exemplary embodiment of method 300 according to the present invention, a tractor 100 including a trailer 120 being shown here in a simplified manner and in a top view, which are coupled to each other with the aid of a connection 130. Tractor 100 includes device 110 according to the present invention and a surroundings sensor system 105. Due to the position of the surroundings sensor system in relation to tractor 100—in particular underneath connection 130—it is possible to detect the surroundings and objects 210, 220, 230 in these surroundings behind tractor 100 through the clearance underneath trailer 120. Here, possible detection ranges 140 are shown merely by way of example, the detected surroundings behind tractor 100 being understood to mean the surroundings behind trailer 120 as well as to the left and/or to the right next to trailer 120. The detection ranges are limited or non-continuous, for example, due to the wheels of trailer 120.

Here, is it shown merely by way of example, how, in this way, for example, an object 210 behind trailer 120 may be detected and determined to be an obstacle, for example, with respect to backing up. Moreover, in this way, for example, a pedestrian next to trailer 120 may be detected as object 220 and determined to be a person or a potential risk. Moreover, in this way, for example, a further vehicle next to trailer 120 may be detected as object 230 and a driving maneuver of this vehicle and, depending thereon, a driving strategy for tractor 100 may be determined, for example, on the basis of the radiation characteristic (flashers, etc.) of the further vehicle.

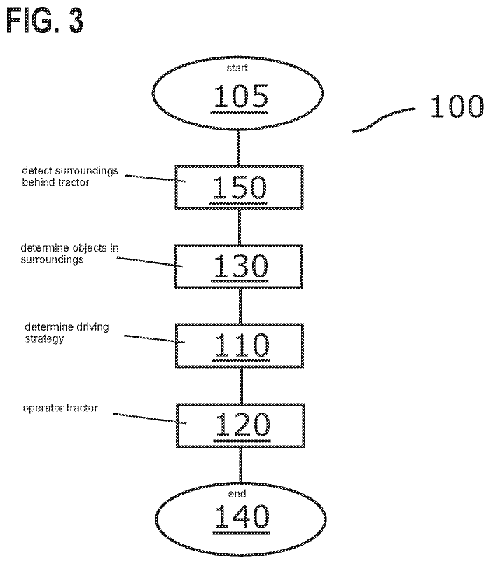

FIG. 3 shows an exemplary embodiment of a method 300 for operating 340 a tractor 100 including a trailer 120.

Method 300 starts in step 301.

In step 310, the surroundings behind tractor 100 are detected through the clearance underneath trailer 120 with the aid of a surroundings sensor system 105.

In step 320, objects 210, 220, 230 in these surroundings, which are not encompassed by trailer 120, are determined by individual, in particular moving, integral parts of trailer 120 being recognized as such and excluded in a targeted manner.

In step 330, a driving strategy for tractor 100 is determined depending on objects 210, 220, 230 in the surroundings.

In step 340, tractor 100 is operated depending on the driving strategy.

Method 300 ends in step 350.

What is claimed is:

1. A method for operating a tractor including a trailer, comprising the following steps:
detecting surroundings behind the tractor through a clearance underneath the trailer using a surroundings sensor system which is mounted close to the roadway surface from the tractor underneath a connection between the tractor and the trailer, the surroundings sensor system including at least one video sensor;
determining objects in the surroundings, which are not encompassed by the trailer, by recognizing individual integral parts of the trailer as parts of the trailer and excluding the individual integral parts of the trailer in a targeted manner;
determining a driving strategy for the tractor depending on the objects in the surroundings; and
operating the tractor depending on the driving strategy.

2. The method as recited in claim 1, wherein the recognized individual parts of the trailer include moving parts of the trailer.

3. The method as recited in claim 1, wherein the individual integral parts of the trailer are excluded by distinguishing the individual integral parts from the objects in the surroundings by utilizing an optical flow.

4. The method as recited in claim 1, wherein a neural network is used for determining the objects and/or for excluding the individual integral parts of the trailer.

5. The method as recited in claim 1, wherein the determination of the objects includes determining a radiation characteristic of at least one further vehicle in the surroundings and the determination of the driving strategy is carried out depending on the radiation characteristic.

6. The method as recited in claim 1, wherein the surroundings are detected using the surroundings sensor system additionally including at least one further, non-identical sensor, and the objects are determined using the surroundings detected using the video sensor fused with the surroundings detected with the at least one further, non-identical sensor.

7. The method as recited claim 6, wherein the at least one further, non-identical sensor is a radar sensor.

8. A device, comprising:
a control unit configured to operate a tractor including a trailer, the control unit configured to:
detect surroundings behind the tractor through a clearance underneath the trailer using a surroundings sensor system which is mounted close to the roadway surface from the tractor underneath a connection between the tractor and the trailer, the surroundings sensor system including at least one video sensor;
determine objects in the surroundings, which are not encompassed by the trailer, by recognizing individual integral parts of the trailer as parts of the trailer and excluding the individual integral parts of the trailer in a targeted manner;
determine a driving strategy for the tractor depending on the objects in the surroundings; and
operate the tractor depending on the driving strategy.

9. A non-transitory machine-readable memory medium on which is stored a computer program for operating a tractor including a trailer, the computer program, when executed by a computer, causing the computer to perform the following steps:
detecting surroundings behind the tractor through a clearance underneath the trailer using a surroundings sensor system which is mounted close to the roadway surface from the tractor underneath a connection between the tractor and the trailer, the surroundings sensor system including at least one video sensor;
determining objects in the surroundings, which are not encompassed by the trailer, by recognizing individual integral parts of the trailer as parts of the trailer and excluding the individual integral parts of the trailer in a targeted manner;
determining a driving strategy for the tractor depending on the objects in the surroundings; and
operating the tractor depending on the driving strategy.
